(19) United States
(12) Patent Application Publication
(10) Pub. No.: US 2008/0252446 A1
(43) Pub. Date: Oct. 16, 2008

(54) Power hand tool with data collection and storage and method of operating

(75) Inventor: Ralph Dammertz, Palatine, IL (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignees: Credo Technology Corporation, Broadview, IL (US); Robert Bosch GmbH, Stuttgart (DE)

(21) Appl. No.: 11/787,297

(22) Filed: Apr. 16, 2007

(51) Int. Cl. H04Q 7/00

(52) U.S. Cl. 340/539.27; 235/440; 340/539.11; 340/584; 340/595; 408/16

(57) ABSTRACT

The invention provides a system and method of monitoring at least one operating characteristic of a hand power tool. In one embodiment, a hand power tool includes a housing, a motor within the housing and a tag mounted on the housing. The tag includes a first antenna for harvesting energy from an electromagnetic field associated with the motor, a microprocessor configured to operate using the harvested energy, a memory including stored commands which, when executed by the microprocessor, cause data associated with a sensed condition of the hand power tool to be stored within the memory, and a second antenna for coupling with a radio frequency identification (RFID) reader and for transmitting the data stored within the memory to the RFID reader.

### FIELD OF THE INVENTION

The present invention relates to a power hand tool and more particularly to a motorized power hand tool.

### BACKGROUND

Power tools including battery operated tools are well-known. These tools typically include an electric motor having an output shaft that is coupled to a spindle for holding a tool. The tool may be a drill bit, sanding disc, a de-burring implement, or the like. Electrical power is supplied to the electric motor from a power source. The power source may be provided to the power tool through a cord. Alternatively, the power source may be a battery source such as a Ni-Cad or other rechargeable battery that may be de-coupled from the tool to charge the battery and coupled to the tool to provide power.

These power tools may be returned to a manufacturer or sent to a repair facility for a variety of reasons. Many of the reasons for returning a power tool are very benign. By way of example, some hand power tools may be returned for routine maintenance. Additionally, many retailers offer a limited time money back guarantee on products sold. Accordingly, many power hand tools are purchased, taken home and then returned simply because the purchaser has reconsidered the purchase. Other returns may be precipitated by the discovery of a minor cosmetic blemish on the power hand tool. Still other power tools may have been used as demonstration tools. Tools that have been returned to a manufacturer for reasons other than operational problems such as those described above can be rapidly refurbished and sold as a factory reconditioned unit without undue concern that the unit will fail.

In some instances, however, a power tool is returned because an operational issue has arisen. By way of example, a hand drill may have been over-torqued, thereby damaging the power drill. If such damage occurs within the retailer guaranteed time frame, however, some customers may return the power tool without alerting the retailer of the damage to the power tool. Such damage may be difficult to discover. For example, a drill may only malfunction at certain speeds or at certain torques. Nonetheless, it is important that any such damage be discovered during the inspection and testing conducted by the factory to avoid mistakenly selling an inferior product.

Other power tools are returned to a manufacturer under a warranty. Typically, at least some of the operational issues of such power tools are identified by the purchaser. Frequently, however, the manner in which the tool was being operated at the time the operational problem developed may not be accurately reported. The actual operating condition at the time of the failure, however, may implicate the manufacturer's obligations under a warranty program. Moreover, information as to how a tool has failed provides insight into potential design changes that can be made to preclude failures in updated versions of the tool.

There is a need to obtain data indicative of the manner in which a tool has been operated. There is a further need to be able to obtain that data without the need to breech the housing of the tool. There is also a need for a system that could easily be retrofitted onto hand power tools.

### SUMMARY

Some of the limitations of previously known hand power tools may be overcome by a system and method of monitoring at least one operating characteristic of a hand power tool including harvesting energy from the motor of a hand power tool and storing data corresponding to a sensed condition of the hand power tool in a memory using the harvested energy.

In one embodiment, a hand power tool includes a housing, a motor within the housing and a tag mounted on the housing. The tag includes a first antenna for harvesting energy from an electromagnetic field associated with the motor, a microprocessor configured to operate using the harvested energy, a memory including stored commands which, when executed by the microprocessor, cause data associated with a sensed condition of the hand power tool to be stored within the memory, and a second antenna for coupling with a radio frequency identification (RFID) reader and for transmitting the data stored within the memory to the RFID reader.

One method of monitoring at least one operating characteristic of a hand power tool includes harvesting energy from the motor of a hand power tool and storing data corresponding to a sensed condition of the hand power tool in a memory using the harvested energy.

In an alternative embodiment, a method of diagnosing a problem in a hand power tool includes harvesting energy from an electromagnetic field associated with the motor of the hand power tool with a tag, storing data corresponding to a sensed condition of the hand power tool within a memory located on the hand power tool using the harvested energy, obtaining the data corresponding to the sensed condition from the memory, comparing the obtained data to reference data, and determining that a problem exists with the hand power tool based upon the comparison.

In a further embodiment, a method of monitoring the operating characteristics of a hand power tool includes attaching a radio frequency identification (RFID) film to the hand power tool, harvesting energy from the motor of the hand power tool with a first antenna located on the RFID film, powering components on the RFID film with the harvested energy, storing data corresponding to a sensed condition of the hand power tool within a memory located on the RFID film, transmitting the data corresponding to the sensed condition from the memory using a second antenna located on the RFID film and analyzing the transmitted data to determine an operating characteristic of the hand held power tool.

### BRIEF DESCRIPTION OF THE DRAWINGS

The present invention may take form in various system and method components and arrangement of system and method components. The drawings are only for purposes of illustrating exemplary embodiments and are not to be construed as limiting the invention.

FIG. 1 shows a perspective view of a power assisted tag attached to an articulating drill incorporating features of the present invention;

FIG. 2 shows a perspective view of the articulating drill of FIG. 1 with the battery pack, a portion of the main housing cover, and a portion of the head housing removed and a bit in the bit holder;

FIG. 3 shows a perspective view of the power assisted tag of FIG. 1 with various layers of the power assisted tag partially peeled apart;

FIG. 4 shows an electrical diagram/schematic of the power assisted tag of FIG. 1 including a harvesting coil and a transmitter/receiver coil;

FIG. 5 shows an electrical diagram/schematic of a reader that can be used to receive data stored in the memory of the power assisted tag of FIG. 1;

FIG. 6 shows a perspective view of a power assisted tag attached to a circular saw incorporating features of the present invention; and

FIG. 7 shows an electrical diagram/schematic of the power assisted tag of FIG. 6 including a harvesting coil and a transmitter/receiver coil.

### DESCRIPTION

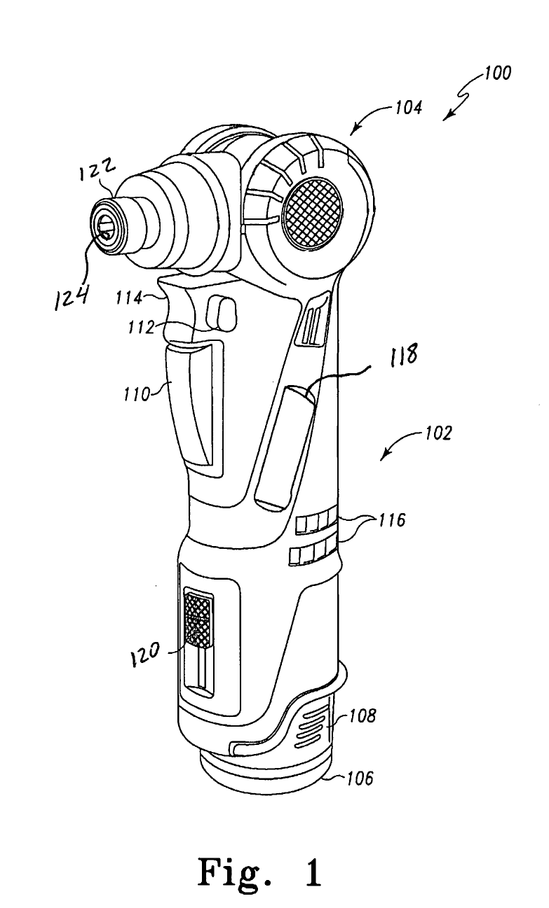

A power tool generally designated 100 is shown in FIG. 1. In the embodiment of FIG. 1, the power tool 100 is a drill which includes a main housing portion 102 and a head portion 104. The main housing portion 102 houses a motor and associated electronics for control of the drill 100. The main housing portion 102 includes a battery receptacle for receiving a rechargeable battery pack 106 as is known in the art. In one embodiment, the rechargeable battery pack 106 comprises a lithium-ion battery. The battery pack 106 is removed by depression of the battery release tabs 108. The drill 100 may alternatively be powered by an external power source such as an external battery or a power cord.

A variable speed trigger switch 110 controls the speed at which the motor rotates. The direction of rotation of the motor is controlled by a reversing button 112 which slides within a finger platform 114. Ventilation openings 116 allow for cooling air to be circulated around the motor inside of the main housing 102. A power assisted tag 118 is located on the main housing portion 102 above the ventilation openings 116.

A clutch control 120 sets the maximum torque that may be generated when using the drill 100. At the position shown in FIG. 1, the clutch control 120 is at the highest setting or drill mode. At the highest setting, the clutch is disabled to provide maximum torque. By sliding the clutch control 120 downwardly from the position shown in FIG. 1, a user may set a desired torque limit that is allowed to be generated by the drill 100. Accordingly, at settings other than the highest setting, a torque above the setting of the clutch control 120 causes the clutch to activate.

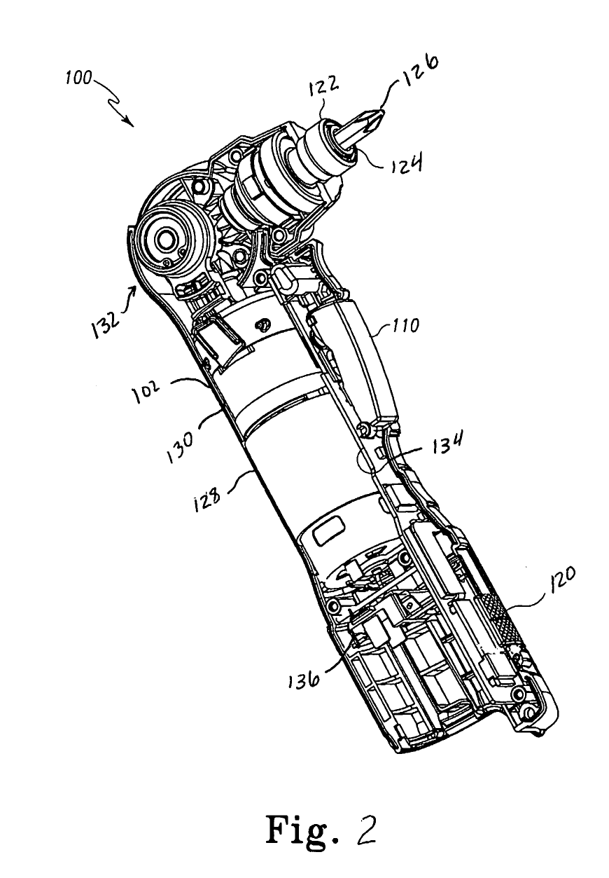

The head portion 104 includes a collet locking device 122 which is located around a bit holder 124. The collet locking device 122 cooperates with the bit holder 124 to hold a bit 126 as shown in FIG. 2. A motor 128 located in the main housing portion 102 provides rotational energy for the bit 126. Rotational energy from the motor 128 is passed to the bit 126 through a planetary gear system 130 and an articulating gear system 132.

The motor 128 is electrically connected to a printed circuit board 134 which in turn is electrically connected to a battery contact holder 136. The contact holder 136 mates with battery pack receptacles on the battery pack 106 and transmits battery power to the printed circuit board 134. The printed circuit board 134 includes a half-bridge rectifier circuit which converts the direct current from the battery pack 106 to an alternating current which is used to cause the motor 128 to rotate.

Referring to FIG. 3, the power assisted tag 118 includes a label surface substrate 140, an RFID substrate 142 and a backing substrate 144. The label surface substrate 140 protects the RFID substrate 142. Additionally, a design and/or information may be printed onto the label surface substrate. An adhesive (not shown) may be applied to the backing substrate 144 to provide for adherence of the power assisted tag 118 to the drill 100.

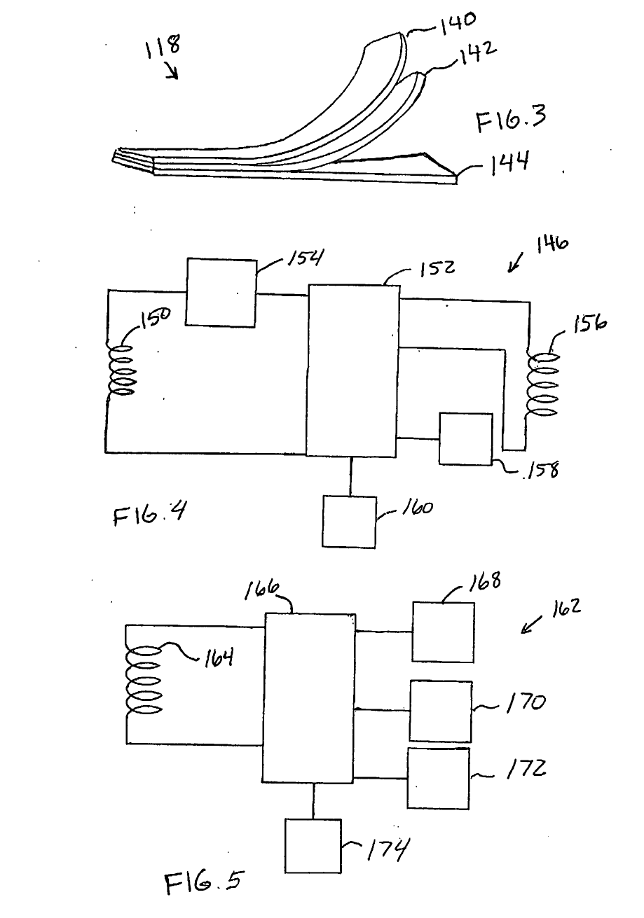

The RFID substrate 142 includes a printed circuit 146 which is schematically shown in FIG. 4. The printed circuit 146 includes a harvesting coil 150 which is connected to a microprocessor 152 through a rectifier and power conditioning unit 154. A data transmitter/receiver coil 156 and a memory 158 are also connected to the microprocessor 152. In this embodiment, a sensor 160 is further connected to the microprocessor 152.

The sensor 160 may be, for example, an accelerometer, displacement sensor, strain gauge, thermometer, or electromagnetic field (EMF) sensor. The sensor 160 provides a signal to the microprocessor 152 indicative of a sensed condition. The printed circuit 146 may include signal conditioners such as an A/D converter (not shown) to provide a signal conditioned to be used by the microprocessor as is known in the relevant art.

The microprocessor 152 executes programs stored within the memory 158, which is preferably a non-volatile memory, and sends signals indicative of a condition sensed by the sensor 160 to the memory 158 for storage. The microprocessor 152 further executes programs which manage communications through the data transmitter/receiver coil 156. The data transmitter/receiver coil 156 also provides power to the printed circuit 146 when the power assisted tag 118 is being read as discussed below. The harvesting coil 150 provides power to the printed circuit 146 when the drill 100 is in operation.

A reader 162 that may be used with the power assisted tag 118 is schematically shown in FIG. 5. The reader 162 includes a coil 164, a microprocessor 166, a power source 168, a graphic user interface (GUI) 170, a memory 172 and an input/output (I/O) device 174. Power for the reader 162 is provided by the power source 168 which may be battery. The microprocessor 166 executes programs stored within the memory 172, which is preferably a non-volatile memory. The memory 172 may further be used to store data received from the coil 164, the GUI 170 and the I/O device 174. The microprocessor 166 further executes programs which manage communications through the input/output device 174 and the GUI 170. The GUI 170 includes a display screen for displaying information to a user as well as a keyboard or other input device whereby the user may control the operation of the reader 162. The coil 164 is used to couple the reader 162 with the power assisted tag 118.

In operation, a user activates the drill 100 by compressing the variable speed trigger switch 110 which closes a circuit between the rechargeable battery pack 106 and the half-bridge rectifier circuit on the printed circuit board 134. The half bridge rectifier circuit is controlled to provide an alternating current to the motor 128. Specifically, the current is applied to the motor 128 in a known manner to generate a switching electromagnetic field. The switching electromagnetic field generates a force on the rotator (not shown) of the motor 128 causing the rotator to rotate which thus initiates an operating window.

Additionally, as the electromagnetic field is rotated, the electromagnetic field sweeps across and couples with the harvesting coil 150. The coupling of the moving electromagnetic field with the harvesting coil 150 induces a current in the harvesting coil 150 which is conducted to the rectifier and power conditioning unit 154. The rectifier and power conditioning unit 154 receives the current from the harvesting coil 150 and converts the current into a stable DC voltage which powers the microprocessor 152 and associated components. In one embodiment, the microprocessor 152 causes a counter (not shown) to be incremented each time a stable DC voltage is initially provided. The counter may thus be used to identify the number of on/off cycles of the drill 100.

The sensor 160, which in this embodiment is an EMF sensor, also detects the electromagnetic field generated by the motor 128. The sensor 160 then passes a signal to the microprocessor 152 indicative of the rate at which the electromagnetic field is rotating through the sensor 160. The microprocessor 152 receives the signal from the sensor 160. In one embodiment, the data correlating to the signal is stored in the memory 158 along with a time tag. Alternatively, the microprocessor 152 may perform some level of signal processing, and store the processed data in the memory 158. Processing of the signal received from the sensor 160 may be desired to compress the data prior to storage in the memory 158.

The microprocessor 152 may further store data identifying the direction of rotation of the motor 128 in the memory 158. This may be accomplished, for example, by identifying the position of the reversing button 112. Likewise, the position of the clutch control 120 may be stored in the memory 158. If desired, the commands executed by the microprocessor 152 may vary the periodicity at which the various data is stored. For example, data corresponding to the position of the reversing button 112 and the clutch control 120 may be recorded only when the sensor 120 detects the start of an operating window. Rather than using a time tag, the duration of the operating window could then be determined by determining the number of data points stored during the particular window. Alternatively, data corresponding to the position of the reversing button 112 or the clutch control 120 may further be recorded each time that the position of the reversing button 112 or the clutch control 120 is repositioned during an operating window.

When the operator no longer desires rotation of the motor 128, the variable speed trigger switch 110 is released. Accordingly, the circuit between the rechargeable battery pack 106 and the half-bridge rectifier circuit on the printed circuit board 134 is broken. Therefore, the half bridge rectifier circuit ceases to provide an alternating current to the motor 128 and the electromagnetic field is no longer switched. Accordingly, the motor 128 ceases to rotate.

Additionally, because the electromagnetic field is either no longer coupled with the harvesting coil 150 or not moving, current is no longer induced within the power assisted tag 118. Therefore, the rectifier and power conditioning unit 154 is de-energized, removing power from the microprocessor 152. Accordingly, no further data associated with the signal from the sensor 160 is stored in the memory 158 and the operating window is closed.

In the foregoing example, the commands executed by the microprocessor 152 set the number of samples of sensed data collected per second, the duration of data collection, the periodicity with which data was stored, and whether the data stored was an instantaneous reading from the sensor 160 or an integrated value. Additionally, while the embodiment of FIG. 4 shows a single sensor 160, other embodiments include multiple sensors. In such embodiments, the periodicity and sequence of sampling of the sensors may be controlled by the commands executed by the microprocessor.

Moreover, the rectifier and power conditioning unit 154 may be constructed to allow for some amount of residual power after the motor 128 is de-energized. Accordingly data may continue to be stored for a period of time after the operating window closes.

The data stored in the memory 158 may thereafter be used, for example, by a maintenance facility when the drill 100 is presented for maintenance, refurbishment, etc. To obtain the data from the memory 158, the reader 162 is energized. The operator then uses the GUI 170 to control the microprocessor 166 to obtain the data stored in the memory 158. In response to the user input, the microprocessor executes commands stored in the memory 172 which causes energy to be applied to the coil 164. The energization of the coil 164 causes an electromagnetic field to be generated which couples with the data transceiver/receiver coil 156.

The coupling of the transceiver/receiver coil 156 provides energy to the microprocessor 152, thereby energizing the microprocessor 152. The microprocessor 166 then causes the electromagnetic field to be modulated, thereby transmitting a command to the microprocessor 152 to transmit data stored in the memory 158. The microprocessor 152 detects the command and executes commands whereby data in the memory 158 is read. The microprocessor then transmits the data through the transceiver/receiver coil 156. The transmitted data is received by the coil 164 and passed to the microprocessor 166. The received data is then stored within the memory 172. Additionally or alternatively, the received data may be displayed on the GUI 170 or re-transmitted through the I/O device 174.

Once the data has been transmitted from the power assisted tag 118, the data may be used to determine a variety of information. By way of example, the number of operating windows as well as the runtime of the drill 100 may be determined. Additionally, the strength of the electromagnetic field sensed by the sensor 160 can be associated with the torque which was exerted by the drill 100 during the operating windows.

The information that is desired may vary over the course of the useful life of a tool. Accordingly, the particular sensor or suite of sensors used may be determined so as to provide all of the information desired over the life of a particular tool. Alternatively, the sensor or suite of sensors used for the particular tool may be varied by the addition of sensors and/or the replacement of the power assisted tag. Such modifications may include, the addition of a temperature sensor which allows for the temperature of a critical component to be determined. Thus, in the event that a particular component is determined to exhibit degraded characteristics, increased monitoring of the component is possible.

Moreover, the power assisted tag may be incorporated into a network of sensors which may be power assisted, passive or active. Thus, a plurality of temperature sensors may be positioned at locations on or near various components of a power hand tool that allow for the determination of the operating temperature of the various components while an EMF sensor could be placed at a location that optimizes coupling with the electromagnetic field generated by the motor of the tool. The information from the temperature sensors and/or the EMF sensor may then be transmitted to the power assisted tag for later transmission.

The information obtained from a power assisted tag may be used for a variety of analysis. For example, the information may be stored to provide trending data over the life of the power tool. The trending data provides may be used to predict when future maintenance will be required. The data may also be compared to stored data for diagnoses of problems with the power hand tool.

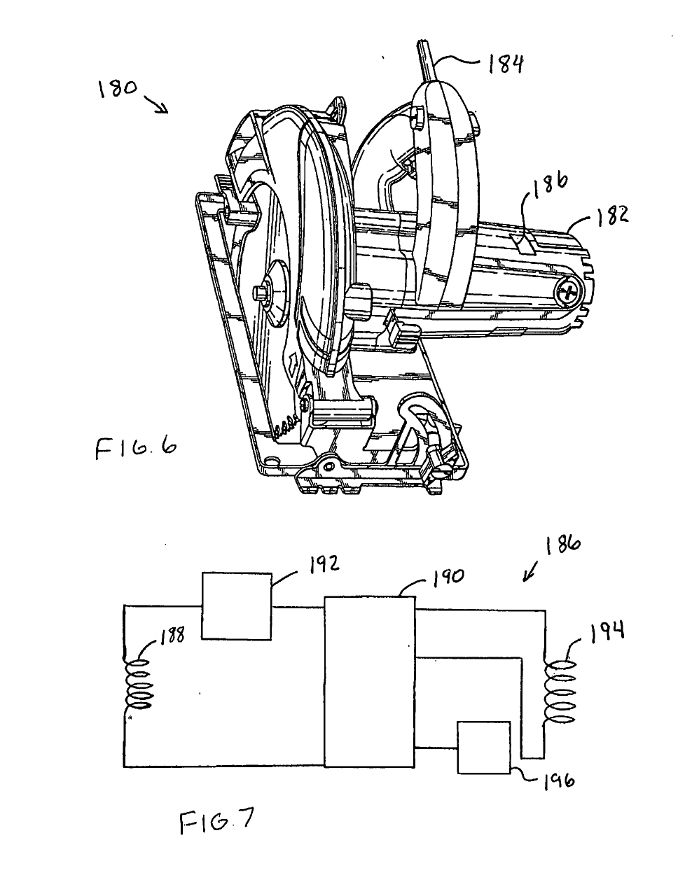

In an alternative embodiment, a power assisted tag which may be an RFID tag may be used in conjunction with an alternating current motor in a power tool. By way of example, FIG. 6 depicts a circular saw 180. The saw 180 includes a housing 182 and a power cord 184. The power cord 184 is used to provide power to the saw 180. A power assisted tag 186 is located on the housing 182. An AC motor (not shown) is located within the housing.

The power assisted tag 186 is schematically shown in FIG. 7. The power assisted tag 186 includes a harvesting coil 188 which is connected to a microprocessor 190 through a rectifier and power conditioning unit 192. A data transmitter/receiver coil 194 and a memory 196 are also connected to the microprocessor 190.

In the embodiment of FIG. 7, the power assisted tag 186 does not include a dedicated sensor. Rather, the harvesting coil 188 is used as a sensor. Specifically, when an alternating current is applied to the motor (not shown) in a known manner, a rotating electromagnetic field is generated by the stator windings (not shown). The rotating electromagnetic field sweeps across and couples with the harvesting coil 188. The coupling of the moving electromagnetic field with the harvesting coil 188 induces a current in the harvesting coil 188 which is conducted to the rectifier and power conditioning unit 192. The rectifier and power conditioning unit 192 receives the current from the harvesting coil 188 and converts the current into a stable DC voltage which powers the microprocessor 190 and associated components. The microprocessor 190 may include a counter (not shown) to be incremented when an operating window is initiated in the foregoing manner. The counter may thus be used to identify the number of on/off cycles of the tool 180.

In the same manner as the drill 100, the speed of rotation of the tool 180 may be determined from the rate at which the electromagnetic field generated by the tool 180 rotates as sensed by the harvesting coil 188. Additional operational insight into the tool 180 may be obtained through the voltage and current produced by the harvesting coil 188 which may be stored in the memory 196. For example, as the torque on the circular saw 180 increases, the strength of the electromagnetic field generated in the stator increases resulting in a higher inductive current from the harvesting coil 188.

Because the electromagnetic field generated by an AC motor generally has a magnetic flux larger than that of the electromagnetic field generated by a switching magnetic field of the type set discussed above with respect to the drill 100, a smaller harvesting coil may be used. Alternatively, the power assisted tag may be placed at a location on the housing which is located in a weaker portion of the rotating electromagnetic field. If additional power is required, then a power assisted tag may be directly wired to the power supply for the motor. In a further embodiment, the harvesting coil of a power assisted tag may be configured as a transformer with a core so as to harvest energy from the stator windings.

While the present invention has been illustrated by the description of exemplary processes and system components, and while the various processes and components have been described in considerable detail, applicant does not intend to restrict or in any limit the scope of the appended claims to such detail. Additional advantages and modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

1. A hand power tool comprising:
a housing;
a motor within the housing; and
a tag mounted on the housing, the tag including
a first antenna for harvesting energy from an electromagnetic field associated with the motor,
a microprocessor configured to operate using the harvested energy,
a memory including stored commands which, when executed by the microprocessor, cause data associated with a sensed condition of the hand power tool to be stored within the memory, and
a second antenna for coupling with a radio frequency identification (RFID) reader and for transmitting the data stored within the memory to the RFID reader.

2. The hand power tool of claim 1, further comprising:
a first sensor for sensing a first condition of the hand power tool and for providing a signal to the microprocessor indicative of the first sensed condition.

3. The hand power tool of claim 2, wherein the first sensor is located within the housing and the signal indicative of the first sensed condition is wirelessly transmitted to the tag.

4. The hand power tool of claim 2, wherein:
the first sensor is for sensing temperature; and
the tag includes a second sensor for sensing the electromagnetic field of the motor and for providing a signal to the microprocessor indicative of the electromagnetic field of the motor.

5. The hand power tool of claim 1, wherein the tag comprises an RFID film.

6. The hand power tool of claim 1, wherein the memory further includes stored commands which, when executed by the microprocessor, cause data associated with an electromagnetic field sensed by the first antenna to be stored within the memory.

7. A method of monitoring at least one operating characteristic of a hand power tool comprising:
harvesting energy from the motor of a hand power tool; and
storing data corresponding to a sensed condition of the hand power tool in a memory using the harvested energy.

8. The method of claim 7, further comprising:
obtaining the data corresponding to the sensed condition from the memory; and
determining an operating characteristic of the hand power tool based upon the comparison.

9. The method of claim 7, wherein harvesting energy comprises:
harvesting energy from a magnetic field associated with a motor of the hand tool.

10. The method of claim 9, wherein:
the method further comprises providing a radio frequency identification (RFID) member; and
harvesting energy further comprises harvesting energy from the magnetic field using a first RFID member coil.

11. The method of claim 10, further comprising:
activating the RFID member with a radio frequency identification (RFID) reader;
accessing the memory using a chip included in the RFID member; and
transmitting the stored data to the RFID reader.

12. The method of claim 11, wherein:
transmitting comprises transmitting the stored data using a second RFID member coil.

13. The method of claim 10, further comprising:
sensing a condition of the hand power tool with an RFID member sensor.

14. The method of claim 13, wherein sensing a condition comprises sensing the start time of the motor, the method further comprising:
associating a time with the sensed condition.

15. The method of claim 13, wherein sensing a condition comprises sensing the electromagnetic field generated by the motor, the method further comprising:
associating the sensed electromagnetic field with a torque on the motor.

16. The method of claim 13, wherein sensing a condition comprises:
sensing a temperature, the method further comprising:
associating the sensed temperature with a temperature of a component of the hand power tool.

17. The method of claim 7, further comprising:
sensing a rotating electromagnetic field with a component, and wherein harvesting comprises harvesting energy from the electromagnetic field using the component; and
storing comprises storing data corresponding to the magnitude of the sensed rotating electromagnetic field using the harvested energy.

18. The method of claim 17, further comprising:
generating the rotating electromagnetic field from an alternating current power supply using stator windings in the hand power tool.

19. The method of claim 18, wherein generating comprises:
generating the rotating electromagnetic field from an alternating current power supply external to the hand power tool.

20. The method of claim 17, further comprising:
incrementing a counter located on the hand power tool to identify the start of an operating window.

21. A method of diagnosing a problem in a hand power tool comprising:
harvesting energy from an electromagnetic field associated with the motor of the hand power tool with a tag;
storing data corresponding to a sensed condition of the hand power tool within a memory located on the hand power tool using the harvested energy;
obtaining the data corresponding to the sensed condition from the memory;
comparing the obtained data to reference data; and
determining that a problem exists with the hand power tool based upon the comparison.

22. The method of claim 21, wherein obtaining the data comprises:
activating the tag with a radio frequency identification (RFID) reader;
accessing the memory using a chip included in the tag; and
transmitting the data to the RFID reader.

23. The method of claim 22, wherein:
harvesting energy comprises harvesting energy using a first coil included in the tag; and
transmitting comprises transmitting the data using a second coil included in the tag.

24. The method of claim 21, further comprising:
sensing a condition of the hand power tool with a sensor included in the tag.

25. The method of claim 24, wherein sensing a condition comprises sensing the start time of the motor, the method further comprising:
associating a time with the sensed condition.

26. The method of claim 24, wherein sensing a condition comprises sensing the electromagnetic field generated by the motor, the method further comprising:
associating the sensed electromagnetic field with a torque on the motor.

27. The method of claim 24, wherein sensing a condition comprises:
sensing a temperature, the method further comprising:
associating the sensed temperature with a temperature of a component of the hand power tool.

28. A method of monitoring the operating characteristics of a hand power tool comprising:
attaching a radio frequency identification (RFID) film to the hand power tool;
harvesting energy from the motor of the hand power tool with a first antenna located on the RFID film;
powering components on the RFID film with the harvested energy;
storing data corresponding to a sensed condition of the hand power tool within a memory located on the RFID film;
transmitting the data corresponding to the sensed condition from the memory using a second antenna located on the RFID film; and
analyzing the transmitted data to determine an operating characteristic of the hand held power tool.

29. The method of claim 28, further comprising:
sensing an electromagnetic field associated with the motor; and
associating the stored transmitted data with a torque on the motor.

30. The method of claim 28, further comprising:
coupling an RFID reader with the second antenna;
activating a microprocessor on the RFID film through the second antenna; and
receiving the transmitted data with the RFID reader.

31. The method of claim 28, further comprising:
storing the transmitted data in a memory remote from the hand held power tool.

32. The method of claim 28, further comprising:
sensing data corresponding to a sensed condition with a sensor located on the RFID film.

33. The method of claim 30, further comprising:
determining a usage profile of the hand held power tool based upon the analysis.

34. The method of claim 28, further comprising:
determining a torque profile of the hand held power tool based upon the analysis.

35. The method of claim 28, further comprising:
determining a temperature profile of the hand held power tool based upon the analysis.
